(19) United States
(12) Patent Application Publication
(10) Pub. No.: US 2003/0148156 A1
(43) Pub. Date: Aug. 7, 2003

(54) Fuel cell constructions

(75) Inventor: Stephen Vernon Barnett, Preston (GB)

Correspondence Address: DANA L. TANGREN, WORKMAN NYDEGGER & SEELEY, 1000 EAGLE GATE TOWER, 60 EAST SOUTH TEMPLE, SALT LAKE CITY, UT, 84111, US

(73) Assignee: British Nuclear Fuels PLC

(21) Appl. No.: 10/299,594

(22) Filed: Nov. 19, 2002

Related U.S. Application Data
(63) Continuation of application No. PCT/GB01/01878, filed on Apr. 30, 2001.

(30) Foreign Application Priority Data
May 19, 2000 (GB) 0012095.6

(51) Int. Cl. H01M 8/04

(52) U.S. Cl. 429/26; 429/34; 429/13

(57) ABSTRACT

A fuel cell system includes one or more fuel cells, one or more of the fuel cells including an electrolyte material, a first electrode and first electrical conductor on one side of the electrolyte material and a second electrode and second electrical conductor on the other side of the electrolyte material, the electrolyte material of a fuel cell defining a fuel space, the fuel space being connected to a fuel supply, within the system, the one or more fuel cells being provided within an oxidant space, the oxidant space being connected to an oxidant supply, the oxidant space and one or more fuel spaces being provided within a gas impermeable barrier, the gas impermeable barrier defining a heating space outside of the gas impermeable barrier, a source of heat being provided in the heating space.

### CROSS-REFERENCE TO RELATED APPLICATIONS

This application claims priority to Great Britain Application No. 0012095.6, filed May 19, 2000 and PCT Application No. PCT/GB01/01878, filed Apr. 30, 2001, which applications are incorporated herein by specific reference.

### BACKGROUND OF THE INVENTION

1. The Field of the Invention

This invention concerns improvements in and relating to fuel cell constructions, particularly, but not exclusively to their format and configuration.

2. The Relevant Technology

Fuel cells produce electrical energy by consumption of fuel at an anode and of an oxidant at a cathode. For the electrochemical reaction to occur at a meaningful rate such fuel cells are generally operated at temperatures in excess of 850° C. Circular cross-section tubular fuel cells are gaining in popularity as it is believed they offer superior resistance to thermal shock; that is to say rapid changes in temperature do not result in large scale damage to the fuel cell. This is an important attribute in real world systems. Circular cross-sectioned tubular fuel cells do have problems, however, in maintaining the fuel, oxidant and exhaust streams sufficiently separate from one another. Various complex arrangements have been used to achieve this. Additionally the cells only function at elevated temperatures and again various complex arrangements have been suggested to achieve this.

### SUMMARY OF THE INVENTION

The present invention has amongst its aims the provision of a structure which avoids exhaust gas contamination of the fuel cell. The present invention has amongst its aims the provision of a reliable, simple and cost effective fuel cell structure.

According to a first aspect of the invention we provide a fuel cell system, the system including one or more fuel cells,

one or more of the fuel cells including an electrolyte material, a first electrode and first electrical conductor on one side of the electrolyte material and a second electrode and second electrical conductor on the other side of the electrolyte material, the electrolyte material of a fuel cell defining it a fuel space, the fuel space being connected to a fuel supply,

within the system the one or more fuel cells being provided within an oxidant space, the oxidant space being connected to an oxidant supply, the oxidant space and one or more and fuel spaces being provided within a gas impermeable barrier, the gas impermeable barrier defining outside it a heating space outside of the gas impermeable barrier, a source of heat being provided in the heating space.

The oxidant and fuel space may be provided within the barrier by providing a barrier which separates the oxidant from the heat source until the oxidant has flowed pass the fuel cells. The oxidant and fuel space may be provided within the barrier by providing a barrier of at least 90% of the extent of the majority of the fuel cells, ideally of all the fuel cells. More preferably the barrier is at least as long as the extent of the majority of, ideally all of, the fuel cells. Preferably the barrier reaches or passes through a plane corresponding to the ends of the majority of the fuel cells, ideally all of the fuel cells. The barrier extent may be at least 105% the extent of the majority of, ideally all of, the fuel cells. The oxidant and fuel space may be provided within the barrier by providing a barrier with an axial extent when considered parallel to the axial extent of the fuel cells, the axial extent of the barrier being at least 95% that of the majority of the fuel cells, ideally of all the fuel cells. The extent may be at least 100%, more preferably at least 110% and ideally at least 120% of the majority of the fuel cells, ideally of all the fuel cells. The oxidant and fuel space may be provided within the barrier by providing a barrier which encloses the oxidant space fully, potentially with one or more apertures in the barrier. The aperture(s) may be provided in the side, but are more preferably provided in the end, of the barrier.

Preferably the maximum separation between the outside of a fuel cell and the inside of the gas impermeable barrier is lass then 5 cm, preferably less than 3 cm and ideally less than 1 cm.

The heating space may be enclosed by an insulating material. One or more apertures may be provided in the insulating material to provide access for the heat source. The heating space may be in contact with the oxidant space and/or fuel space.

The source of heat may be a flame, preferably a flame from burning a feed other than the fuel and oxidant not consumed by the fuel cells. The source of heat may be a fluid, particularly a gas. The source of heat may be an exhaust gas. The source of heat may be catalytic combustion. The source of heat may be directed at the barrier. The flame may touch the barrier.

The system may include a plurality of fuel cells. Preferably the system includes 2 to 50 fuel cells, more particularly 4 to 30 fuel cells and ideally 6 to 16 fuel cells. The fuel cells may be evenly spaced from one another in the oxidant space. The fuel cells may be provided around the perimeter of the oxidant space. The fuel cells, or a majority of them, may be closer to the barrier than to the centre of the oxidant space.

Preferably all the fuel cells are the same shape. The fuel cells are preferably all the same size.

Preferably the fuel cells are tubular. Preferably the fuel space is defined within the electrolyte layer. Preferably the fuel cells are cylindrical, ideally right cylinders. Preferably the fuel space within the fuel cell is tubular, more preferably cylindrical and ideally a right cylinder. The fuel cells are preferably at least 10 times as long as their maximum diameter. Preferably the fuel cell has the same internal and/or external cross-section throughout the oxidant space.

The electrolyte material is preferably provided as a tube. Preferably the electrolyte material is cylindrical, ideally a right cylinder. Preferably the fuel space within the electrolyte material is tubular, more preferably cylindrical and ideally a right cylinder. Preferably the electrolyte material has the same internal and/or external cross-section throughout the oxidant space.

The electrolyte material is preferably an oxide. The electrolyte material may be zirconia, particularly zirconia doped with yttria.

The first electrode is preferably provided in contact with the oxidant space. The second electrode is preferably provided in contact with the fuel space. The first electrical conductor is preferably provided in contact with the oxidant space. The second electrical conductor is preferably provided in contact with the fuel space.

The first electrode may be continuous, at least over a portion of the electrolyte layer surface. The first electrode may be provided as a layer. The first electrode of the fuel cell may particularly be the cathode.

The first electrical conductor may be discontinuous. Preferably the first electrical conductor is provided in contact with an opposing surface of the first electrode to the surface of the first electrode the electrolyte contacts. The first electrical conductor may be provided as a layer. The first electrical conductor maybe helical. The first electrical conductor may be a wire. The first electrical conductor may be silver. The first electrical conductor may be a spring.

The first electrode and/or first electrical conductor may be provided throughout the oxidant space. The first electrode and/or electrical conductor may be provided in a portion of the oxidant space removed from the oxidant source to that space. The portion may start in the 50% the length of the oxidant space removed from the oxidant source to that space. The portion may end at the end of the oxidant space or in the last 5% thereof. The first electrical conductor is preferably connected to a further electrical conductor. Preferably the further electrical conductor, either directly or indirectly, connects the first electrical conductor and second electrical conductor.

The second electrical conductor may be continuous, at least over a portion of the electrolyte layer surface. The second electrode may be provided as a layer. The first electrode may be of a thickness which varies along the length of the fuel cell. Preferably first electrode has a first portion of greater thickness than a second portion, the first portion being closer to the location at which the fuel is introduced than the second portion fuel. The second electrode of the fuel cell may particularly be the anode.

The second electrical conductor may be dis-continuous. Preferably the second electrical conductor is provided in contact with an opposing surface of the second electrode to the surface of the second electrode the electrolyte contacts. The second electrical conductor may be provided as a layer. The second electrical conductor may be helical. The second electrical conductor may be a wire. The second electrical conductor may be of silver. The second electrical conductor may be a spring.

The second electrode and/or second electrical conductor may be provided throughout the fuel space. The second electrode and/or second electrical conductor may be provided in a portion of the fuel space removed from the fuel source to that space. The portion may start in the 50% the length of the fuel space removed from the fuel source to that space. The portion may end at the end of the fuel space or in the last 5% thereof. The second electrical conductor is preferably connected to a further electrical conductor.

Preferably a single fuel space is defined within a single fuel cell. Preferably the fuel space extends from the fuel source to the space to the end of the fuel cell. Preferably the fuel space and/or fuel cell is open ended. The fuel cell may have a single opening in the end.

The fuel space may be connected to the fuel supply directly. The fuel space may be connected to the fuel supply by a chamber which receives a fuel supply. Preferably all the fuel cell fuel spaces are connected to a single chamber.

The oxidant space may be tubular, preferably cylindrical and ideally a right cylinder. The oxidant space is preferably open at the end removed from the oxidant source for the oxidant space. The opening may be the same cross-section as the cross-section of the oxidant space.

The oxidant may be connected to the oxidant supply directly. The oxidant space may be connected to the oxidant supply by a chamber which receives an oxidant supply.

The barrier may be tubular, preferably cylindrical and ideally a right cylinder. The barrier is preferably open at the end removed from the oxidant source for the oxidant space. The opening may be the same cross-section as the cross-section of the barrier. The barrier may be formed of a metal oxide, metal or metal alloy.

According to a second aspect of the invention we provide a method of producing a fuel cell, the method including:

producing one or more fuel cells, one or more of the fuel cells including an electrolyte material, a first electrode and first electrical conductor to one side of the electrolyte material and a second electrode and second electrical conductor to the other side of the electrolyte material, the electrolyte material defining within it a fuel space;

connecting the fuel space of the one or more fuel cells to a fuel supply;

providing a gas impermeable barrier around the fuel cells, the barrier defining within it an oxidant space and outside it a heating space;

connecting the oxidant space to an oxidant supply.

The method may further comprise the use of the fuel cell. Preferably the use includes the introduction of the barrier to a heat source. The barrier may be introduced to a flame and/or a hot gas flow.

The second aspect of the invention may include any of the features, options or possibilities set out elsewhere in this document.

According to a third aspect of the invention we provide a method of producing electricity, the method including:

providing a fuel sell system, the system including one or more fuel cells, one or more of the fuel cells including an electrolyte material, a first electrode and first electrical conductor on one side of the electrolyte material and a second electrode and second electrical conductor on the other side of the electrolyte material and a second electrode and second electrical conductor to the other side of the electrolyte material, the electrolyte material defining a fuel space;

within the system, the one or more fuel cells being provided within an oxidant space, the oxidant space and the one or more fuel spaces being provided within a gas impermeable barrier, the gas impermeable barrier defining a heating space outside of the gas impermeable barrier;

supplying fuel to the fuel space, an oxidant to the oxidant space and applying heat to the heating space.

The fuel may be introduced through a fuel preparation device. The fuel preparation device may have a raw fuel input and processed fuel output. The raw fuel may be cleaned before outputting. The raw fuel may be converted before outputting. The fuel may be hydrogen. The raw fuel may be converted from a hydrogen containing form to hydrogen. The fuel and/or raw fuel may be butane and/or propane. The fuel may be processed or converted by one or more of the fuel cells, particularly at the anode. Fuel processing and/or conversion may take place preferentially to current generation at one portion of the fuel cell. Current generation may take place preferentially to fuel processing or conversion at another portion of the fuel cell. The another portion may be further than the portion from the fuel inlet. The another portion and portion of the fuel cell may have different electrode characteristics, particularly thickness.

The third aspect of the invention may include any of the features, options or possibilities set out elsewhere in this document.

### BRIEF DESCRIPTION OF THE DRAWINGS

Various embodiments of the invention will now be described, by way of example only, and with reference to the accompanying drawings in which:

FIG. 1 illustrates an embodiment of a fuel cell assembly according to the present invention; and

FIG. 2 illustrates a further embodiment of a fuel cell assembly according to the present invention.

### DETAILED DESCRIPTION OF THE PREFERRED EMBODIMENTS

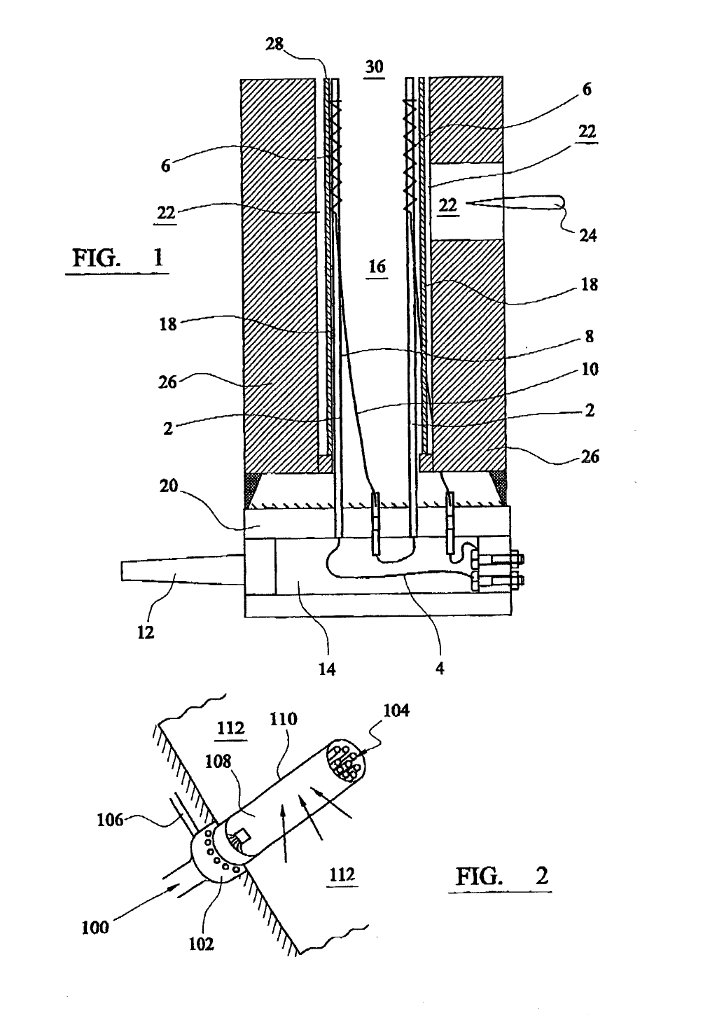

In the fuel cell construction illustrated in FIG. 1 a series of hollow tubes 2 form the fuel cells. Each of these fuel cells is defined by a wall formed of a gas impermeable electrolyte layer, for instance of zirconia. On each side of the electrolyte layer, an electrically conductive element is provided to form the electrical circuit. This likely to be a first electrode and a first electrical conductor used to complete the electrical circuit.

In the illustrated form, the inner surface of the wall is provided with a helical spiral electrode which is connected to lead 4. The outer surface is provided with a wound conductor 6 which spirals around the electrolyte layer 8 and is connected to lead 10. The fuel, hydrogen, is introduced into the tubes through inlet 12 and chamber 14 into which the bottom ends of the tubes 2 open.

The tubes 2 are all provided in a space 16 which is fully enclosed at the sides by a single barrier 18. The barrier 18 is gas impermeable. The oxidant is fed to the space 16 through chamber 20; in many cases convection will achieve a sufficient oxidant flow.

To heat the construction at least to the point where the fuel cell reactions start to operate, the barrier 18 is in contact with a flow of hot gas around its outside, in the space 22. The gas may enter the space 22 sufficiently hot to achieve its heating purpose, or, as shown, a flame 24 may be provided to achieve the heating. In the illustrated example an insulating layer 26 is provided around the construction to maintain the temperature. The insulating layer may be cooled, actively or passively in various designs. The insulating layer may be designed to heat up, potentially with the heat being used for a further purpose.

The hydrogen fuel fed into the tubes 2 and oxygen fed into the space 16 form the reactants for the fuel cells. Negative oxygen ions are formed on the outside surface of the wall 8, anode, and flow inward and react with hydrogen ions at the inner surface of the wall 8, cathode. A current is generated by the flow of electrons, produced by the ionisation of the hydrogen, around the circuit formed by the wall 8, the conductors on the anode and cathode surfaces respectively, and the leads 4, 10.

The unconsumed fuel and reaction products exit the tubes 2 through the open ends 28 at the top. The unconsumed oxygen exits via the open top 30 of the space 16. The two streams may be burnt here completely and/or upon combination with the hot gases as they exit the space 22.

The mounting of the tubes 2 in the chamber 14 is relatively simple to seal of the fuel, as is the sealing of the barrier 18 to seal off the oxidant and hot gas from one another. Additionally the construction ensures good separation between the heat source/gases and the fuel/oxidant system thereby avoiding any contamination or other detrimental effects. Additionally the construction means that the necessary heat can be easily introduced.

The provision of this type of fuel cell construction allows it to be readily deployed in a number of existing situations which could provide the necessary heat. For instance, as shown in FIG. 2 a fuel supply line 100 leads to a distribution chamber in the base 102 of a construct and hence to the inside of the tubes 104. A oxygen supply line 106, pressurised (for instance by a fan) leads to a further chamber in the base 102 and hence to the central space 108 which surrounds the tubes 104 on all sides. The space 108 is defined on its outside by a metal oxide barrier 110 which protrudes into a heating space 112 provided with a hot gas flow and/or flame. The space 112 may be within an existing heating device, such as a boiler, car exhaust or the like.

What is claimed is:

1. A fuel cell system including one or more fuel cells, the system comprising:
one or more of the fuel cells including an electrolyte material, a first electrode and first electrical conductor on one side of the electrolyte material and a second electrode and second electrical conductor on the other side of the electrolyte material, the electrolyte material of a fuel cell defining a fuel space, the fuel space being connected to a fuel supply,
within the system, the one or more fuel cells being provided within an oxidant space, the oxidant space being connected to an oxidant space being connected to an oxidant supply, the oxidant supply, the oxidant space and one or more fuel spaces being provided within a gas impermeable barrier, the gas impermeable barrier defining a heating space outside of the gas impermeable barrier, a source of heat being provided in the heating space.

2. A system according to claim 1 in which the oxidant and fuel space are provided within the barrier by providing a barrier which separates the oxidant from the heat source until the oxidant has flowed past the fuel cells.

3. A system according to claim 1 in which the oxidant and fuel space are provided within the barrier by providing a barrier of at least 90% of the extent of the majority of the fuel cells.

4. A system according to claim 1 in which the heating space is enclosed by an insulating material.

5. A system according to claim 1 in which the source of heat is a flame.

6. A system according to claim 1 in which the source of heat is an exhaust gas.

7. A system according to claim 1 in which the system includes 2 to 50 fuel cells.

8. A system according to claim 1 in which the fuel cells are tubular and the fuel space is defined within the electrolyte layer.

9. A system according to claim 1 in which the oxidant space is open at the end removed from the oxidant source for the oxidant space.

10. A method of producing a fuel cell system, the method comprising:
producing one or more fuel cells, one or more of the fuel cells comprising an electrolyte material, a first electrode and first electrical conductor to one side of the electrolyte material and a second electrode and second electrical conductor to the other side of the electrolyte material, the electrolyte material defining a fuel space;
connecting the fuel space of the one or more fuel cells to a fuel supply;
providing a gas impermeable barrier around the fuel cells, the barrier defining within it an oxidant space and outside it a heating space; and
connecting the oxidant space to an oxidant supply.

11. A method of producing electricity, the method comprising:
providing a fuel cell system, the system comprising one or more fuel cells, one or more of the fuel cells including an electrolyte material, a first electrode and first electrical conductor on one side of the electrolyte material and a second electrode and second electrical conductor on the other side of the electrolyte material, the electrolyte material of a fuel cell defining a fuel space;
within the system, the one or more fuel cells being provided within an oxidant space, the oxidant space and the one or more fuel spaces being provided within a gas impermeable barrier, the gas impermeable barrier defining a heating space outside of the gas impermeable barrier;
supplying fuel to the fuel space, an oxidant to the oxidant space and applying heat to the heating space.
